(19) United States
(12) Patent Application Publication
(10) Pub. No.: US 2008/0078492 A1
(43) Pub. Date: Apr. 3, 2008

(54) Tamper evident and resisting informational article and method of producing same

(75) Inventor: Salvatore D'Amato, Mocksville, NC (US)

Correspondence Address: FULBRIGHT & JAWORSKI, LLP, 666 FIFTH AVE, NEW YORK, NY, 10103-3198, US

(73) Assignee: AMERICAN BANK NOTE HOLOGRAPHICS, INC.

(21) Appl. No.: 11/906,601

(22) Filed: Oct. 3, 2007

Related U.S. Application Data
(60) Provisional application No. 60/849,296, filed on Oct. 3, 2006.

(51) Int. Cl. B32B 37/14

(52) U.S. Cl. 156/60; 283/94

(57) ABSTRACT

A method of protecting an informational article including providing an informational article substrate having a zone for inserting variable information within the zone, and securing a transparent tape, preferably see-through holographic layer having a write-resistant exposed surface over the information.

### RELATED APPLICATION

The present application claims the benefit of U.S. Provisional Application Ser. No. 60/849,296, filed Oct. 3, 2006, which is incorporated herein by reference in its entirety.

### FIELD OF THE INVENTION

The present invention relates to informational articles which are provided with a zone within which information is provided either in handwritten or printed form and, more specifically, it relates to providing such an article resistant to both counterfeiting, through photocopying, and alteration through manual or printed means.

### BACKGROUND OF THE INVENTION

It has been known for many purposes to provide means to protect informational articles from counterfeiting and alteration. For example, special inks, graphic designs, codes, holograms and materials have been used to make it more difficult for counterfeiters to copy the paper currency. Also, cards have been encased between a pair of laminated plastic sheets to protect them from deterioration and alteration. Further, holograms have been employed in credit cards to inhibit unauthorized reproduction.

However, a unique problem still exists for protecting certain items which must be completed by an intermediary after initial manufacture and prior to delivery to the end user. For example, a state prints on paper or paperboard all of the information required for a temporary registration plate except for the expiration date. The temporary registration plate is used by the new car owner until the permanent license plate is received. The expiration date is typically applied with a pen, marker or other printing means by the car dealer at the time of the sale of the vehicle. It is important that the temporary plate be designed such that it cannot be easily counterfeited by photocopying and the information provided thereon by the dealer, such as the expiration date, cannot be altered.

Therefore, the present invention proceeds upon the desirability of providing an informational article that are resistant to counterfeiting and alteration, and a method of protecting such informational article from counterfeiting and alteration. For example, temporary vehicle registration plates that are resistant to counterfeiting and alteration after the insertion of the required information, such as the expiration date, by the car dealer.

### OBJECT AND SUMMARY OF THE INVENTION

It is an object of the present invention to provide an information article and a method of producing same with overcomes the aforementioned problems. An efficient means for resisting counterfeiting by photocopying or alteration of the informational article. The information article resists counterfeiting by photocopying and/or alteration, and resists alteration of the information inserted onto the information article by an authorized intermediary.

It is an another object of the present invention to provide such an informational article and the method for producing same wherein the informational article is not effective until additional information is added thereto, e.g., the temporary registration plate is not effective until the expiration date is added thereon.

It is a further object of the present invention to provide the informational article and method as aforesaid, which applies a write resistant treated transparent tape comprising a refractive image over the additional information.

It is a still another object of the present invention to provide the informational article and method as aforesaid, which can be employed economically and without the need for special skills or equipment on the part of the individual (i.e., the intermediary) completing the informational article by adding the required additional information.

It is a yet another object of the present invention to provide a refractive image in the write resistant treated transparent tape which comprises a tamper evident feature.

In accordance with an exemplary embodiment of the present invention, the informational article has a preprinted side containing base or basic information and a zone on the preprinted side for subsequent insertion of additional information by an intermediary. For example, the preprinted side of the information article can contain base information, such as the state in which the temporary registration plate is effective, and the zone can be used by the car dealer to insert the expiration date. It is appreciated that such temporary registration plates must be sufficiently large to be viewable from a distance by a law enforcement officer without getting out of her vehicle, thereby enabling the law enforcement officer to quickly determine whether the temporary vehicle registration is valid or expired.

In accordance with an exemplary embodiment, the present invention provides an overlay pattern which preferably is a refractive image, such as a hologram, so as to resist reproduction, such as photocopying. Preferably, the hologram is de-metalized for see through purposes. The overlay pattern of the present invention is overlaid on top of the informational article's zone containing the information. Efforts to photocopy, even on paper of identical color as the original form would fail to reproduce the refractive image and thereby preclude photocopying as a means of counterfeiting the temporary registration plate.

In accordance with an exemplary embodiment of the present invention, an adhesively bonded transparent tape comprising a refractive image, such as a hologram, can be placed over the zone after the information is inserted thereon by the intermediary, e.g., a car dealer applying the expiration date within the zone. The adhesively bonded transparent tape can be made of a polyester or polyolefin. Preferably, the adhesively bonded transparent tape is covered with a write resistant coating, such as a silicone resin with a wax added thereto, such as polytetrafluoroethylene.

In accordance with an exemplary embodiment of the present invention, the method comprises providing an information article with a zone for inserting information by an intermediary, inserting the information within the zone and thereafter applying the write resistant, adhesively bonded transparent protective tape comprising the refractive image pattern over the zone.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which:

FIG. 1 is a schematic side view of an informational article in accordance with an exemplary embodiment of the present invention;

FIG. 2 is a schematic view of the informational article comprising the additional information and a see through holographic overlay in accordance with an exemplary embodiment of the present invention;

FIG. 3 is a schematic view of the informational article with the see through holographic overlay covering the zone or area of the additional information in accordance with an exemplary embodiment of the present invention;

FIG. 4 is a schematic side elevational sectional view, not to scale, of a tape assembly embodying the present invention in a particular form, attached to a substrate such as a personal identification card, in untampered condition;

FIG. 5 is a similar but exploded view of the tape assembly of FIG. 4, again shown in untampered condition; and

FIG. 6 is a similar view of the same tape assembly after tampering.

### DETAILED DESCRIPTION OF THE EMBODIMENTS

As used herein, the term “refractive image” means any visually perceptible contrasting portion which has contrast increased upon exposure to either natural or artificial light and shall include, but not be limited to photographs, illustrations, printed patterns, colors, and holograms.

As used herein, the term “informational article” means an article or portion thereof which is intended to communicate information and will expressly include, but not be limited to temporary vehicle registration plates, identification cards, security signs, labels and cards, checks, bank drafts, money orders, and other types of informational signs, labels, and cards.

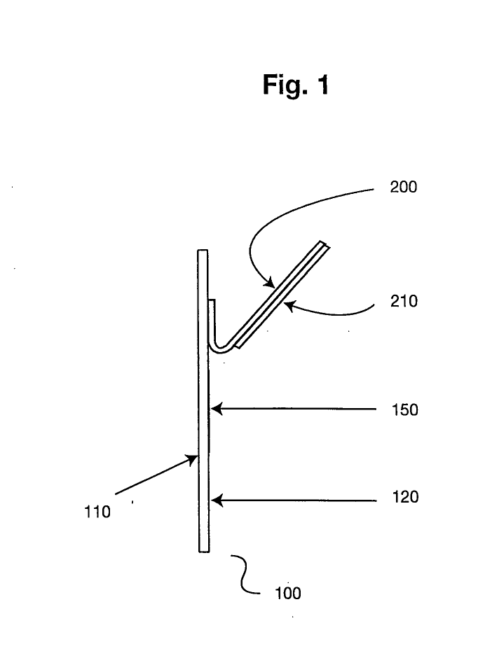

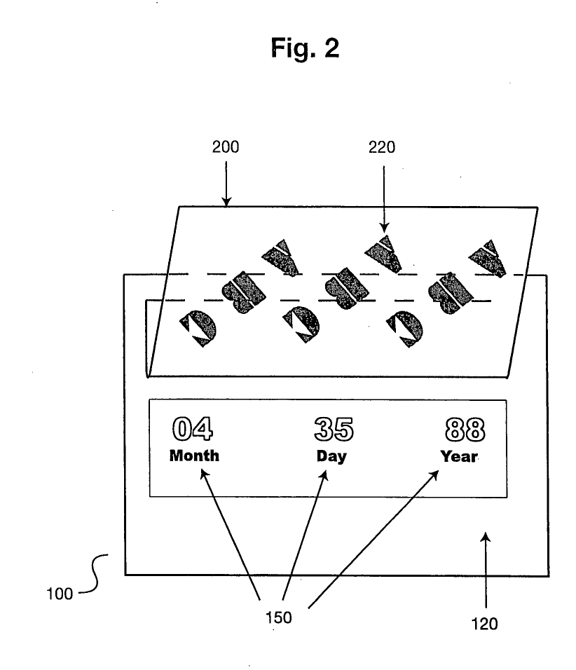

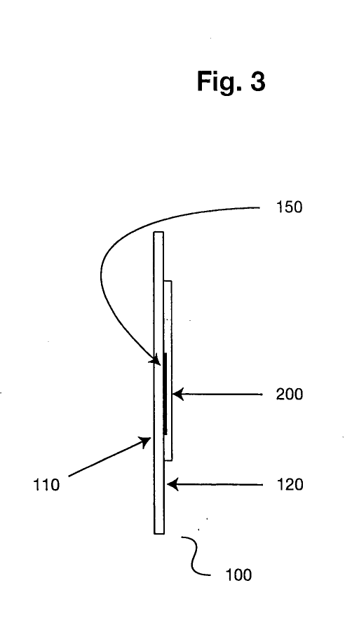

Turning now to FIGS. 1-3, in accordance with an exemplary embodiment of the present invention, the informational article 100 is a paper or paperboard temporary registration form 10 prior to insertion of the expiration date. That is, the present invention is described in conjunction with a completed temporary registration form 110, as shown in FIGS. 1-3. The temporary registration form 110 is generally rectangular in shape and can have the size on the order of about 8 to 12 inches by about 4 to 8 inches. The registration form 110 is printed on one side (i.e., the printed face 120) and has information regarding the state in the upper horizontal portion (not shown). The registration form 110 also has an information receiving zone 150 underlying the horizontal portion within which the expiration date can be inserted by a vehicle dealer using a pen or a marker to provide a thicker line, or by other suitable printing means. For example, the information receiving zone 150 can be disposed above and below the word “EXPIRES” (not shown) on both sides of the information receiving zone 150 to enable a law enforcement officer to view the informational article 100 (i.e., the temporary vehicle registration plate 100) from a distance without getting out of her vehicle, thereby enabling the law enforcement officer to quickly determine whether the temporary vehicle registration plate 100 is valid or expired. The blank space underlying the information receiving zone 150 can be employed to provide a vehicle serial number, if desired.

In accordance with an exemplary embodiment of the present invention, a tape assembly or member 200 is pre-secured to the printed face 120 of the informational article 100 (e.g., a temporary vehicle registration plate 100) by suitable pressure-sensitive adhesive means. The tape assembly 130 which is folded upwardly could be stored in a downward position overlying the information receiving zone 150 containing the required information, such as the expiration date for a temporary vehicle registration plate 100. The tape assembly 200 can comprises a strippable protective web 210 secured to the adhesive side of the tape assembly 200 to resist undesired premature sticking. In accordance with an exemplary embodiment of the present invention, the tape assembly 200 can be made transparent by de-metalizing a metal layer of the diffractive or refractive image. The base material of the tape assembly 200 is preferably composed of a material selected from the group consisting of polyester and polyolefins with polyethylene and polypropylene being among the preferred materials in the latter generic category. The required information (e.g., the expiration date) is inserted within the information receiving zone 150 of the informational article 100. The protective web 210 is then removed from the tape assembly 200 and the protective web 210 is urged downwardly in overlying position with respect to the information provided in the information receiving zone 150 and secured thereto in surface-to-surface contact by means of the pressure-sensitive adhesive on the undersurface of the tape assembly 200. Alternatively, the tape assembly 200 can be provided as a separate member rather than pre-securing to the informational article 100.

In accordance with an exemplary embodiment of the present invention, the tape assembly 200 comprises a pattern, preferably is a refractive image 220, to make the temporary registration form 110 resistant to counterfeiting by photocopying. The refractive image 220 is preferably a hologram, such as a plurality of repeated patterns, such that varying colors can be seen within each information receiving zone 150 as the temporary registration form 110 is moved in either natural or artificial light. As a result, even if a blank temporary registration form 110 is photocopied on paper or paperboard of identical color and design employed by the state, the counterfeiter will not be able to duplicate the color produced by the hologram because it changes with the movement of the temporary registration form 110 in either natural or artificial light. Alternatively, the tape assembly 200 comprises non-holographic patterns or refractive images employed on a reflective background to render the temporary registration form 110 resistant to photocopying. When the dealer sells a vehicle, she inserts, either manually or by printing means, the expiration date of the temporary registration plate 110 within the information receiving zone 150 in large numbers so it is viewable from a substantial distance. The holographic or non-holographic pattern can be integrally provided in the tape assembly 200, provided as a coating to the tape assembly 200 or can be formed on a separate element and adhesively bonded to the tape assembly 200.

The exposed surface of the protective web tape assembly 200 preferably has a coating of a silicone resin to render it resistant to any efforts to write thereon in a manner that would overlay and alter the expiration date. Preferably, a wax is about 2.5 to 10 percent by weight and is incorporated in the silicone resin so as to enhance the write resistant characteristics of the informational article 100, particularly the tape assembly 200, with respect to marker pens, crayons, pens, and the like. This renders the exposed surface of the tape assembly 200 non-wetting with respect to inks. Preferably, the silicone resin is a heat curable resin and the wax is polytetrafluoroethylene.

In accordance with an exemplary embodiment of the present invention, as shown in FIGS. 1-3, the protective tape 200 comprising the refractive images 220 overlies all or part of the information receiving zone 150, which contains the required information, of the informational article 100. The protective tape 200 can be adhesively secured in overlying surface-to-surface position with respect to the information receiving zone 150, thereby rendering the informational article 100 of the present invention resistant to counterfeiting. For example, the temporary registration form 110 of the present invention is resistant to counterfeiting before or after completion. The presence of the transparent tape 200, which is protectively covered, over the information receiving zone 150 of the informational article 100 inhibits unauthorized alteration of the expiration date, such as by changing the numbers or writing over the expiration date.

In accordance with an exemplary embodiment of the present invention, any effort to lift the tape 200 will result in the disruption of the refractive image 220 contained in the tape 200 by use of the tamper evident feature, such as those described in U.S. Pat. No. 6,214,443, which is owned by the common assignee of this application and which is incorporated by reference herein in its entirety. It is appreciated that the tape 200 can be adhered to the informational article 100 using suitable adhesives, such as an acrylic base pressure-sensitive adhesive for informational article 100 made of paper or paperboard and a rubber based adhesive for informational article made of plastic.

In a typical holographic label or overlaminate using radiation casting techniques, the product can be viewed as a two-layer system comprising a clear protective layer and a much thinner holographic layer cast directly onto the protective layer. The holographic image is subsequently made more visible by coating the holographic image side of the label with an ultra thin layer of reflective material. An adhesive layer is finally applied to the reflective side of the label to render the entire system functional as a pressure sensitive holographic label or a holographic overlaminate product. The present invention incorporates the covert security feature by utilizing a tamper evident pattern in the refractive image 220 that remains invisible until the product has been tampered with.

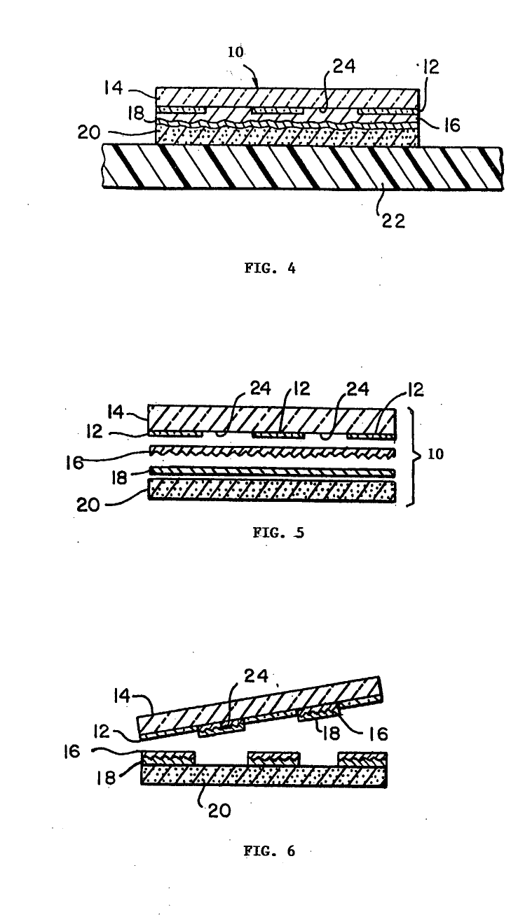

As shown in FIGS. 1-3, the tape assembly 200 comprises a protective web or liner 210 and a refractive image 220, preferably a hologram. In accordance with an exemplary embodiment of the present invention, the process of providing tamper evident feature to the tape assembly 200 will be described in conjunction with FIGS. 4-6. The bond strength between the image layer 16 and the exposed (unpatterned) portions 24 of the surface of protective layer 14 is greater than the shear strength of the image layer 16 and the reflective layer 18; the bond strength between the adhesive layer 20 and the reflective layer 18 is also greater than the shear strength of the image layer 16 and the reflective layer 18; the bond strength between the image layer 16 and the exposed (unpatterned) portions of the surface of protective layer 14 is greater than the bond strength between the adhesive layer 20 and the reflective layer 18; and the shear strength of the protective layer 14 is greater than the shear strength of the image layer 16 and the reflective layer 18.

It is this bond strength differential that allows the final product, i.e., the tape assembly 200, to assume the tamper evident characteristic if tampered with. That is, when stress is applied to remove the label from the surface to which it has been attached by means of an adhesive layer 20, portions of the image layer 16 that come in direct contact with the patterned layer 12 will be readily detached from the patterned portions because of the weaker interfacial bond between the two UV cured resins. On the other hand, in areas where the image layer 16 is directly cast over the non-patterned portions 24 of the protective layer 14, the image layer will remain attached to the protective layer 14 because its bond strength towards the protective film is greater than the adhesive strength between the reflective layer 18 and the base substrate 22. Since the tear strength of the thin UV cast image layer is lower than the adhesive strength between the image layer and the base substrate, the image layer will break in the exact pattern as the patterned layer during the delamination process (as shown in FIG. 6), leaving parts of the image behind on the base substrate and other parts of it on the delaminated portion.

In accordance with an exemplary embodiment of the present invention, the method provides an appropriate form (i.e., appropriate information article 100 with information receiving zone 150), inserts the desired or required information in at least partial overlying relationship with respect to the pattern 220 on the tape member 200 and thereafter covers the information within the information receiving zone 150 by adhesively bonding the transparent tape member 200 comprising the refractive patterns or images 220. Preferably, exterior surface of the transparent tape member 200 is treated or coated to be write resistant using any known methods.

It will be appreciated that the present invention provides a simple and effective means of resisting both counterfeiting and alteration of informational articles 100, such as handicap placards, identification cards, security passes, temporary vehicle registration plates, and the like. The present invention is sufficiently inexpensive to use and can be adapted for use in disposable items.

Although the present invention has been described using the temporary vehicle registration plates, the present application has applicability in other environments wherein counterfeit and alteration protection is desired with particular emphasis in those instances where the producer and authorized user of the information article or form is not the one who puts in additional information. That is, the intermediary (i.e., the car dealer) puts in the additional information (e.g., the expiration date) on the information article (e.g., temporary vehicle registration plate) produced by the state (i.e., the producer) and used by the car owner (i.e., the authorized user). For example, currently available dated or coded security passes for individuals, company, or vehicles (such as governmental or industrial vehicles) can be rendered more reliable using the present invention. While for convenience of disclosure reference has been made herein to use of the present invention on paper or paperboard articles, the present invention is not so limited. It can be used on plastic, metal, or laminated materials, for example. A vinyl or polyvinylchloride can also be employed.

While the foregoing has described and illustrated aspects of various embodiments of the present invention, those skilled in the art will recognize that alternative components and techniques, and/or combinations and permutations of the described components and techniques, can be substituted for, or added to, the embodiments described herein. It is intended, therefore, that the present invention not be defined by the specific embodiments described herein, but rather by the appended claims, which are intended to be construed in accordance with the well-settled principles of claim construction, including that: each claim should be given its broadest reasonable interpretation consistent with the specification; limitations should not be read from the specification or drawings into the claims; words in a claim should be given their plain, ordinary, and generic meaning, unless it is readily apparent from the specification that an unusual meaning was intended.

1. A method of protecting an informational article, on which variable information is inserted thereon, from photocopy duplication and alteration, the method comprising the steps of:
providing a substrate having a zone for inserting said variable information within said zone; and
securing a transparent tape having a write resistant exposed surface comprising a see through refractive image over said variable information such that said informational article resists alteration and photocopy duplication.

2. The method of claim 1, further comprising the step of showing evidence of tampering in the form of a disruption in said refractive image when said transparent tape is tampered with.

3. The method of claim 1, further comprising the step of securing said transparent tape onto a vehicle registration.

4. The method of claim 1, further comprising the step of securing said transparent tape onto a handicap parking placard.

5. The method of claim 1, further comprising the step of securing said transparent tape onto an identification card or a security pass.

6. The method of claim 2, further comprising the step of securing said transparent tape comprising a see-through hologram.

7. The method of claim 1, wherein the step of securing said transparent tape comprises the step of inserting said variable information within said zone and securing said transparent tape over said variable information by an intermediary.

8. An informational article, comprising:
a substrate having a zone for inserting a variable information within said zone; and
a transparent tape having a write resistant exposed surface comprising a see through refractive image over said variable information such that said informational article resists alteration and photocopy duplication.

9. The article of claim 8, wherein said refractive image is disrupted when said transparent tape is tampered with, thereby showing evidence of tampering.

10. The article of claim 8, wherein said informational article is a vehicle registration.

11. The article of claim 8, wherein said informational article is a handicap parking placard.

12. The article of claim 6, wherein said informational article is an identification card or security pass.

13. The article of claim 6, wherein said transparent tape is a see-through hologram.
